(19) United States
(12) Patent Application Publication
(10) Pub. No.: US 2008/0298217 A1
(43) Pub. Date: Dec. 4, 2008

(54) OPTICAL PICKUP DEVICE, OPTICAL DISC APPARATUS INCLUDING OPTICAL PICKUP DEVICE, AND METHOD OF MANUFACTURING OPTICAL PICKUP DEVICE

(75) Inventor: Tooru Washiyama, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/127,419

(22) Filed: May 27, 2008

(30) Foreign Application Priority Data
May 31, 2007 (JP) 2007-145804

(51) Int. Cl. G11B 7/00

(52) U.S. Cl. 369/121

(57) ABSTRACT

An optical pickup device includes a pickup base, an optical system, a light emitting element, and a heat transfer holder which transfers the heat of the light emitting element to the pickup base. The heat transfer holder includes a holder base and a holder main body overlapped to the holder base. The holder base is arranged around the light emitting element and has a first flat contact surface which comes into surface contact with an abutment surface of the pickup base, and a second spherical contact surface, which is positioned opposite to the first contact surface. The holder main body has a third spherical contact surface which comes into surface contact with the second contact surface of the holder base, and an engaging recess formed in the third contact surface and having an inner surface which contacts with the light emitting element.

### CROSS-REFERENCE TO RELATED APPLICATIONS

This application is based upon and claims the benefit of priority from Japanese Patent Application No. 2007-145804, filed May 31, 2007, the entire contents of which are incorporated herein by reference.

### BACKGROUND

1. Field

One embodiment of the present invention relates to an optical disc apparatus including an optical pickup device for recording and replaying information to and from an optical disc such as a compact disc (CD), a digital versatile disc (DVD), and a high definition digital versatile disc (HD-DVD) and to a method of manufacturing the optical pickup device.

2. Description of the Related Art

Optical disc recording and replaying apparatuses (hereinafter, referred to as optical disc apparatuses) include an optical pickup device for recording and replaying data to and from an optical disc as a recording medium. The optical pickup device ordinarily includes a laser diode as a light emitting element for emitting a laser beam, a light receiving element, and an optical system for guiding the laser beam emitted from the laser diode to an optical disc as well as guiding the laser beam reflected by the optical disc to the light receiving element, and these components are mounted on a metal pickup base. The optical system includes, for example, an objective lens, a collimator lens, and a beam splitter.

Recently, it is required to more improve the performance of optical disc apparatuses and to more reduce the thickness thereof. To satisfy the requirement, it is required to accurately adjust the position of the laser diode to the optical system.

In general, a laser diode is adjusted in the 5-axis directions of an X-axis (direction approximately parallel with the surface of the optical disc on a plane orthogonal to the laser beam being emitted), a Y-axis (direction orthogonal to the X-axis on a plane orthogonal to the laser beam being emitted), a Z-axis (direction of the laser beam being emitted), a normal line direction angle (tangent direction, Y- and Z-axes direction angle), and a horizontal direction angle (radial direction, X- and Z-axes direction angle) while monitoring the optical axis and the amount of distribution of the laser beam emitted from a mirror so that the optical axis of the laser diode faces a proper direction. After the laser diode is adjusted, it is fixed to an optical base using an ultraviolet ray curing type adhesive and the like.

In general, a laser diode is fixed to an optical base without coming into direct contact therewith. Accordingly, the heat transfer efficiency from the laser diode to the optical base is deteriorated, and, in particular, the temperature of a high speed recording laser diode having a large calorific value is increased. When the calorific value of the laser diode is increased, heat is radiated insufficient, and thus, there is a possibility that the performance of the laser diode is deteriorated and the life thereof is shortened.

To cope with the above problem, Jpn. Pat. Appln. KOKAI Publication No. 2005-108300, for example, proposes to use a component acting a heat medium between an optical base and a laser diode, that is, to use a holder which is approximately in contact with a stem portion of the laser diode and the optical base and covers the outer periphery of the stem portion of the laser diode in order to improve the heat transfer efficiency between the optical base and the laser diode.

Further, Jpn. Pat. Appln. KOKAI Publication No. 2006-134408, for example, proposes an optical pickup device in which a holder, on which a laser diode is mounted, is connected to an optical base so that the position thereof can be adjusted to the optical base. According to the device, the holder has a sheet metal fixture bonded and fixed to the optical base and a holder main body which holds the laser diode as well as is fixed to the fixture. The position of the holder main body is adjusted to a predetermined position by elastically deforming the fixture.

However, in the optical pickup device disclosed in Jpn. Pat. Appln. KOKAI Publication No. 2005-108300, only the inner engaging portion of the holder comes into contact with the laser diode and almost all the other portions thereof confront with the laser diode through a gap therebetween so that the holder can be mounted on the laser diode mounted at various adjustment positions. Further, when the laser diode is fixed to a position inclining to the optical base, the holder does not sufficiently come into intimate contact with the optical base, and a gap is created therebetween.

Accordingly, in the optical pickup device disclosed in Jpn. Pat. Appln. KOKAI Publication No. 2005-108300, it is difficult to effectively radiate the heat of the laser diode to the optical base through the holder. Although it is also contemplated to fill the gap with heat radiation resin, it is difficult to improve a heat transfer efficiency.

According to the optical pickup device disclosed in Jpn. Pat. Appln. KOKAI Publication No. 2006-134408, the holder main body to which the laser diode is fixed is bonded and fixed to the fixture after the position thereof is adjusted to the optical base by elastically deforming the fixture. Since residual stress remains in the fixture, there is a possibility that the position of the laser diode is changed by variation per hour after it is bonded.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram schematically showing an optical disc apparatus according to an embodiment of the present invention;

FIG. 2 is an exemplary plan view showing an optical disc side of an optical pickup device according to the embodiment of the invention;

FIG. 3 is an exemplary perspective view of an optical system and a laser diode of the optical pickup device when viewed from a lower surface of the optical pickup device;

FIG. 4 is an exemplary sectional view showing the laser diode and a heat transfer holder portion;

FIG. 5 is an exemplary exploded perspective view showing the laser diode and the heat transfer holder;

FIG. 6 is an exemplary exploded perspective view showing the laser diode and the heat transfer holder shown from a direction different from the direction shown in FIG. 4;

FIG. 7 is an exemplary perspective view showing the position adjustment direction of the laser diode to a mounting portion of a pickup base;

FIG. 8 is an exemplary perspective view showing a state that the laser diode is fixed to the pickup base in a process of manufacturing the optical pickup device;

FIG. 9 is an exemplary perspective view showing a state that a holder base is mounted on the laser diode in the process of manufacturing the optical pickup device;

FIG. 10 is an exemplary perspective view showing a state that the holder base and a holder main body are mounted on the laser diode in the process of manufacturing the optical pickup device;

FIG. 11 is an exemplary sectional view showing a state that the laser diode is adjusted and arranged at a position which inclines a certain angle to an ideal position;

FIG. 12 is an exemplary sectional view showing a state that the laser diode is adjusted and arranged at a position which inclines a certain angle to the ideal position as well as offsets in an X-axis direction;

FIG. 13 is an exemplary sectional view showing a state that the laser diode is adjusted and arranged at a position which inclines a certain angle to the ideal position as well as offsets in a Z-axis direction; and

FIG. 14 is an exemplary perspective view showing a holder base of a heat transfer holder and a laser diode according to another embodiment.

### DETAILED DESCRIPTION

Various embodiments according to the invention will be described hereinafter with reference to the accompanying drawings. In general, according to one embodiment of the invention, there is provided an optical pickup device comprising: a pickup base; an optical system held by the pickup base; a light emitting element which emits a laser beam and is fixed to the pickup base in a state that the position of the light emitting element is adjusted to the optical system; and a heat transfer holder which is mounted on the pickup base in contact with the light emitting element and transfers the heat of the light emitting element to the pickup base, the pickup base including a flat abutment surface positioned adjacent to the light emitting element, and the heat transfer holder including: a holder base arranged to surround the light emitting element so as to cause the light emitting element to pass through the holder base, the holder base having a first flat contact surface which comes into surface contact with the abutment surface, and a second spherical contact surface, which is positioned to a side opposite to the first contact surface, the holder base being movable in a surface direction of the abutment surface with respect to the light emitting element; and a holder main body overlapped to the holder base to cover the light emitting element, the holder main body having a third spherical contact surface which comes into surface contact with the second contact surface of the holder base, and an engaging recess formed in the third contact surface and having an inner surface which comes into contact with the light emitting element.

An optical disc apparatus according to an embodiment of the present invention will be explained in detail below referring to the drawings.

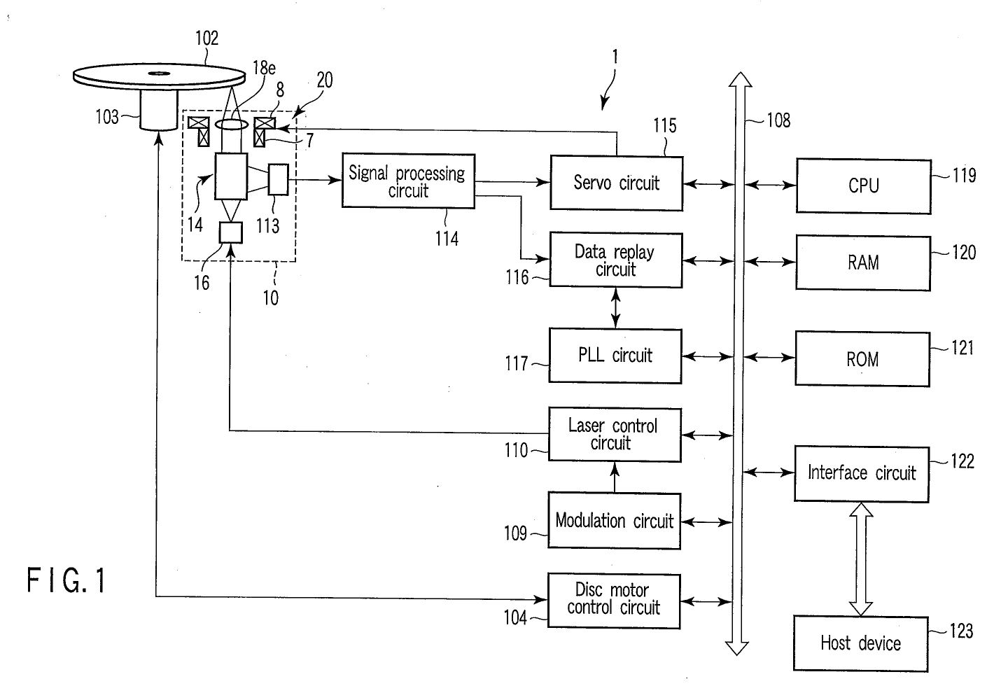

FIG. 1 is a block diagram showing an arrangement of an optical disc apparatus 1. An optical disc 102 is an optical disc such as DVD-RAM to which user data can be recorded. Land tracks and groove tracks are spirally formed on a surface of the optical disc 102, and the optical disc 102 is rotated by a disc motor 103. The disc motor 103 is controlled by a disc motor control circuit 104.

Information is recorded to and reproduced from the optical disc 102 by an optical pickup device 10. An optical system 14 including an objective lens 18e is arranged to the optical pickup device 10. The objective lens 18e can be moved in a focusing direction (optical axis direction of lens) by driving a focusing direction drive coil 7 constituting an adjusting mechanism 20 and can be moved in a tracking direction (track direction of the optical disc 102) by driving a track direction drive coil 8.

A modulation circuit 109 modulates data, which is supplied from a host device 123 through an interface circuit 122, and supplies the modulated data to a laser control circuit 110 when information is recorded. When the information is recorded (when a mark is formed), the laser control circuit 110 supplies a write signal to a laser diode 16 in the optical pickup device 10 based on the modulated data supplied from the modulation circuit 109.

The laser diode 16 emits a laser beam in response to a signal supplied from the laser control circuit 110. The laser beam emitted from the laser diode 16 is radiated to the optical disc 102 through the optical system 14 and the objective lens 18e. The light reflected from the optical disc 102 is guided to a light-receiving element 113 in an optical pickup 5 through the optical system 14. A signal output from the light receiving element 113 is supplied to a signal processing circuit 114.

The signal processing circuit 114 creates a focus error signal and a tracking signal and outputs them to a servo circuit 115. The servo circuit 115 creates a focusing control signal and a tracking control signal. These signals are supplied to a focus direction drive coil and a track direction drive coil of the optical pickup device 10, and the laser beam follows the tracks on the information recording surface of the optical disc 102, thereby the objective lens 18e is controlled so that it is just focused at all times. Further, the signal processing circuit 114 creates a data replay signal of record data and outputs it to a data replay circuit 116.

The data replay circuit 116 replays the record data based on a replay clock signal from a PLL circuit 117. The data reproduced by the data replay circuit 116 is output to a host device 23 through the interface circuit 122 after the error thereof is corrected by an error correction circuit (not shown) using an error correction code provided therewith.

A CPU 119 controls the optical disc apparatus 1 in its entirety according to an operation command supplied from the host device 123 through the interface circuit 122. Further, the CPU 119 uses a random access memory (RAM) 120 as a work area such as a buffer memory and the like when data is recorded and reproduced, and performs a predetermined control according to a program stored in a read only memory (ROM) 121.

Next, the optical pickup device 10 will be explained in detail.

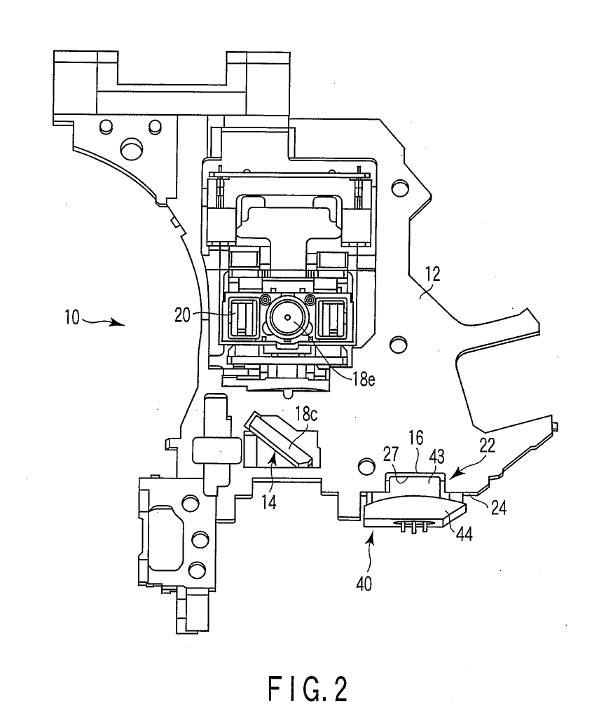

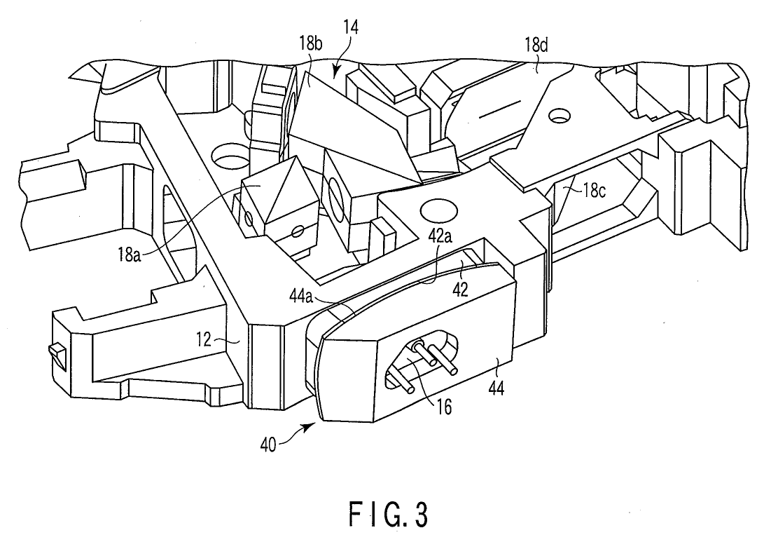

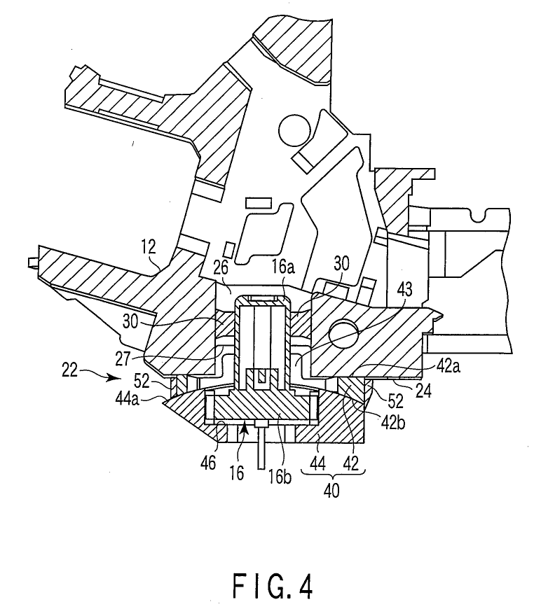

FIG. 2 is a plan view of the optical pickup device when viewed from the upper surface thereof confronting an optical disc (not shown). FIG. 3 is a perspective view showing the optical system and the laser diode of the optical pickup device when viewed from the lower surface of the optical pickup device. FIG. 4 is a sectional view showing the laser diode and a heat transfer holder portion.

As shown in FIGS. 2 and 3, the optical pickup device 10 includes a metal pickup base 12 formed in a flat and approximately rectangular parallelepiped shape. A plurality of concave portions are formed in the pickup base 12, and the optical system 14, the laser diode 16 which constitutes a semiconductor laser as a light emitting element, a receiving element (not shown), and the like are mounted in the concave portions.

The optical system 14 mainly includes a prism 18a, a beam splitter 18b, a mirror 18c, a collimate lens 18d, a standing-up mirror (not shown), the objective lens 18e, and the like. The objective lens 18e is supported by the adjusting mechanism 20 so as to be movable in an optical axis direction and a track direction so that it can perform a focus adjustment and a track adjustment to the optical disc.

The laser beam emitted from the laser diode 16 passes through the beam splitter 18b and is reflected at a predetermined angle by the mirror 18c. Further, the laser beam passes through the collimate lens 18d, is reflected at a predetermined angle by the standing-up mirror, passes through the objective lens 18e, and is radiated to the optical disc 102.

The laser beam reflected by the optical disc 102 passes through the objective lens 18e, the standing-up mirror, and the collimate lens 18d, and is reflected at a predetermined angle by the mirror 18c. The laser beam further passes through the beam splitter 18b, and is received by the light receiving element 113. With this operation, information is recorded to the optical disc 102 or the information recorded to the optical disc is reproduced.

As shown in FIGS. 2 to 4, a mounting portion 22 of the laser diode 16 is formed in the short side edge of the pickup base 12. The mounting portion 22 has an flat abutment surface 24, which opens to an outside, a through hole 26 extending through the abutment surface, and a positioning cutout 27 which is formed adjacent to the through hole and opens to an outside surface.

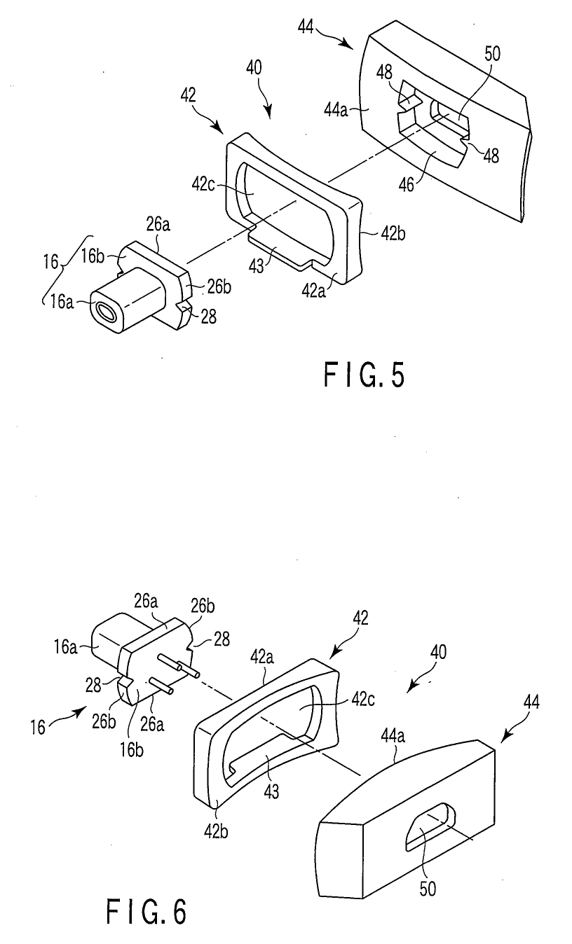

As shown in FIGS. 4, 5 and 6, the laser diode 16 has a cylindrical cap portion 16a having a light emitting end and a stem portion 16b which is larger than the cap portion and arranged on a base end of the cap portion. A plurality of input terminals extend from the stem portion 16b. The stem portion 16b has a cylindrical peripheral surface extending in the optical axis direction of the laser diode, that is, the axial direction of the cap portion 16a. The upper and lower portions of the peripheral surface are cut flat so as to confront approximately in parallel with each other so that they form a pair of flat side surfaces 26a, and the other portion of the peripheral surface forms two cylindrical surfaces 26b confronting each other. V-shaped grooves 28 are formed on the two cylindrical surfaces 26b, respectively, and extend approximately in parallel with the direction in which the laser beam is emitted.

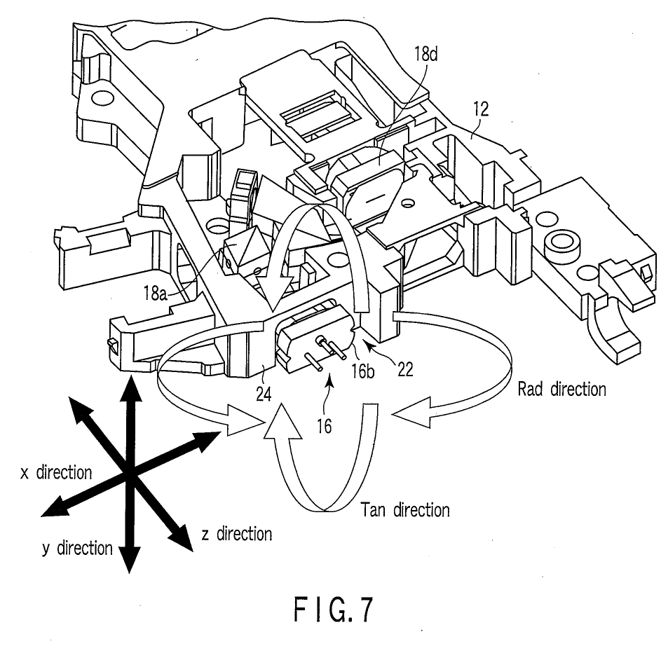

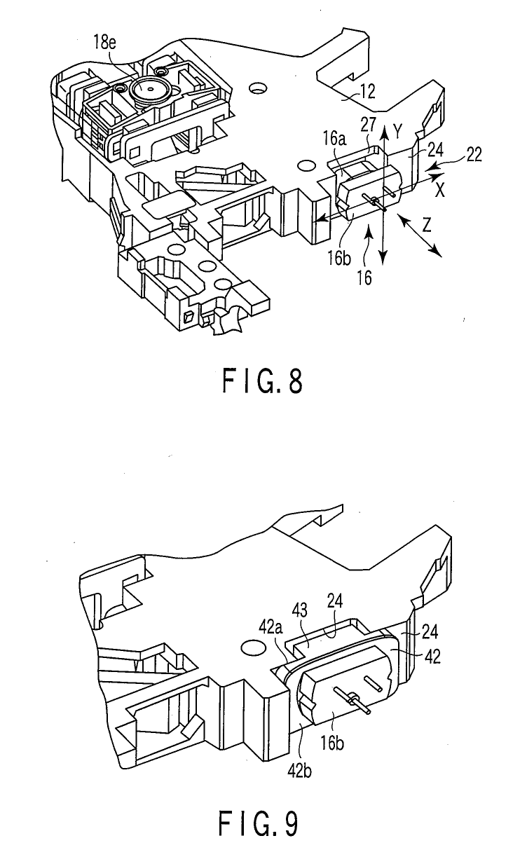

As shown in FIGS. 4 and 7, the laser diode 16 is arranged in such a manner that the cap portion 16a thereof is inserted into the through hole 26 of the pickup base 12 with a gap defined therebetween and the stem portion 16b thereof projects to outside the pickup base. Then, the laser diode 16 is bonded and fixed to the pickup base 12 in the through hole 26 by, for example, an ultraviolet curing type adhesive 30.

The laser diode 16 is fixed to the pickup base 12 after it is adjust to a proper position with respect to the optical system 14. More specifically, the laser diode 16 is adjusted in the 5-axis directions of an X-axis (direction approximately parallel with the surface of the optical disc on a plane orthogonal to the laser beam being emitted), a Y-axis (direction orthogonal to the X-axis on a plane orthogonal to the laser beam being emitted), a Z-axis (direction of the laser beam being emitted), a normal line direction angle (tangent direction, Y- and Z-axes direction angle), and a horizontal direction angle (radial direction, X- and Z-axes direction angle) while monitoring the optical axis and the amount of distribution of the laser beam emitted from the objective lens 18e of the optical system 14, thereby the laser diode 16 is aligned with the optical system 14 so that the optical axis and the amount of distribution of the laser beam are set properly. After the position of the laser diode 16 is aligned, the laser diode 16 is bonded and fixed to the pickup base 12.

As shown in FIGS. 2 to 6, the optical pickup device 10 includes a heat transfer holder 40 for transferring the heat generated in the laser diode 16 to the pickup base 12. The heat transfer holder 40 includes, for example, a rectangular annular shaped holder base 42 and an approximately rectangular parallelepiped holder main body 44 arranged by being overlapped to the holder base. The holder base 42 and the holder main body 44 are formed of a material excellent in heat radiation property and a heat transfer property, for example, aluminum die-cast, zinc die-cast, and the like.

The holder base 42 includes a first flat contact surface 42a, a second concave spherical contact surface 42b positioned to a side opposite to the first contact surface, and an inner hole 42c extending passing through the first and second contact surfaces. The inner hole 42c has a diameter larger than the diameter of the stem portion 16b of the laser diode 16 and is formed so that the stem portion pass through the inner hole 42c from the outside. The holder base 42 is arranged to surround the cap portion 16a of the laser diode 16 in a state that the first contact surface 42a comes into surface contact with the abutment surface 24 of the pick-up base 12, and the holder base 42 is positioned between the abutment surface 24 and the stem portion 16. The position of the holder base 42 can be adjusted in the X- and Y-axis directions, that is, in the surface direction of the abutment surface 24 in a state that the first contact surface 42a is in surface contact with the abutment surface 24.

Further, the holder base 42 has a plate-shaped positioning projection 43 projecting from the lower end of the first contact surface 42a. When the holder base 42 is mounted on the mounting portion 22 of the pick-up base 12, the positioning projection 43 is loosely inserted into the cutout 27 so that the holder base 42 is roughly positioned to the mounting portion 22.

The holder main body 44 is arranged so that it covers the stem portion 16b of the laser diode 16 as well as is overlapped to the holder base 42. The holder main body 44 has a third convex spherical contact surface 44a, which is in surface contact with the second contact surface 42b of the holder base 42, and an engaging recess 46 formed on the third contact surface. The engaging recess 46 is formed in a shape corresponding to the shape of the stem portion 16b. The holder main body 44 is covered to the laser diode 16 in a state that the stem portion 16b is fitted in the engaging recess 46. At the time, at least a portion of the inner surface of the engaging recess 46, that is, approximately the entire periphery of the inner surface thereof in the embodiment comes into contact with the pair of flat side surfaces 26a and the two cylindrical surfaces 26b of the stem portion 16b.

A pair of engaging projections 48 confronting with each other project from the inner surface of the engaging recess 46. These engaging projections 48 are engaged with the V-shaped grooves 28 of the stem portion 16b, respectively. Note that a gap may defined between the bottom surface of the engaging recess 46 and the end face of the stem portion 16b. An opening 50 is formed on the bottom surface of the engaging recess 46. The input terminals projecting from the stem portion 16b extend passing through the opening 50.

The holder main body 44 is mounted at a position following the X- and Y-axes directional position and the tangent and radial directional position excluding the Z-axis direction by mounting the holder main body 44 on the laser diode 16 in a state that the outer peripheral surface of the stem portion 16b is in surface contact with the inner surface of the engaging recess 46. The third convex spherical contact surface 44a abuts against the second contact surface 42b of the holder base 42 by mounting the holder main body 44 to the stem portion 16b from the outside in the Z-axis direction. At the time, since the second contact surface 42b is formed in the concave spherical surface, the holder base 42 is displaced in the X- and Y-axes direction following the position of the holder main body 44. As a result, the third contact surface 44a comes into surface contact with the second contact surface 42b.

The outer peripheral portions of the holder base 42 and the holder main body 44, which are mounted at the predetermined positions, are bonded to the pickup base 12, thereby the holder base 42 and the holder main body 44 are fixed to the mounting portion 22 of the pickup base. An ultraviolet curing type adhesive 52, for example, can be used to bond them. Note that when a gap is slightly formed between the second contact surface 42a and the third contact surface 44a due to a processing error and the like, the gap may be filled with heat transfer grease.

In the above arrangement, if the laser diode 16 is heated to increase the temperature thereof when the optical pickup device 10 is operated, the heat is transfer to the holder main body 44 and further transferred to the pickup base 12 through the holder base. Then, the heat is radiated to the outside from the heat transfer holder 40 and the pickup base 12. With this operation, the excessive increase of temperature of the laser diode can be prevented.

Next, a method of manufacturing the optical pickup device arranged as described above will be explained.

First, the components such as the optical system 14, the light receiving element, and the focus adjusting mechanism 20 are mounted on the pick-up base 12 and attached to predetermined positions. Subsequently, as shown in FIGS. 6 and 7, after the laser diode 16 is arranged to a mounting portion 24 of the pickup base 12, the laser diode is adjusted to the proper position with respect to the optical system 14. That is, the laser diode 16 is adjusted in at least one direction of the 5-axis directions of the X-axis, the Y-axis, the Z-axis, the tangent direction, and the radial direction while monitoring the optical axis and the amount of light distribution of the laser beam emitted from the objective lens 18e of the optical system 14, thereby the laser diode 16 is aligned so that the optical axis and the amount of distribution of the laser beam are set properly. After the position of the laser diode 16 is adjusted, the cap portion 16a of the laser diode 16 is bonded and fixed to the pickup base 12.

Next, the heat transfer holder 40 is mounted on the laser diode 16. In this case, as shown in FIG. 9, the holder base 42 is moved along the Z-axis direction from the outside of the laser diode 16, and the laser diode is inserted into the inner hole 42c. With this arrangement, the holder base 42 is arranged to the periphery of the laser diode 16 as well as the first contact surface 42a of the holder base is caused to come into surface contact with the abutment surface 24 of the mounting portion 22. In this state, the holder base 42 can be displaced in the X-axis direction and the Y-axes directions along the surface direction of the abutment surface 24.

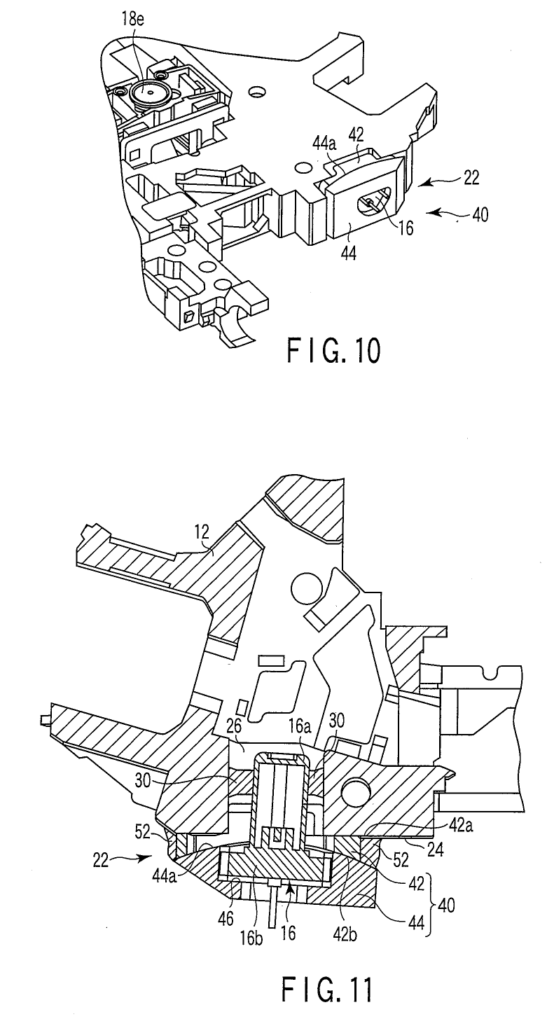

Subsequently, as shown in FIG. 10, the holder main body 44 is moved from the outside of the laser diode 16 in the Z-axis direction and covered to the stem portion 16b of the laser diode as well as the stem portion 16b is engaged with the engaging recess 46 of the holder main body 44. At the time, the holder main body 44 is caused to slide in the Z-axis direction in a state that the engaging projections 48 of the engaging recess 46 are engaged with the V-shaped grooves 28 of the stem portion 16b, respectively.

With this arrangement, the inner surface of the engaging recess 46 comes into surface contact with the outer peripheral surface of the stem portion 16b, and the holder main body 44 is mounted to the position following the X- and Y-axes directional position and the tangent and radial directional position excluding the Z-axis direction with respect to the laser diode whose position is adjusted. Since the holder main body 44 is mounted on the stem portion 16b from the outside in the Z-axis direction, the third convex spherical contact surface 44a is abutted against the second contact surface 42b of the holder base 42. At the time, since the second contact surface 42b is formed in the concave spherical surface, the holder base 42 is displaced in the X-axis direction and the Y-axis direction following the position of the holder main body 44. As a result, the third contact surface 44a comes into surface contact with the second contact surface 42b.

Thereafter, the outer peripheral portions of the holder base 42 and the holder main body 44 are bonded to the pickup base 12 by, for example, the ultraviolet ray type curing adhesive 52. With this operation, the heat transfer holder 40 is mounted on the mounting portion 22 of the pickup base. Note that when the gap is slightly defined between the second contact surface 42a and the third contact surface 44a due to the processing error and the like of the holder, the gap may be filled with the heat transfer grease. Further, when a gap is defined between the inner surface of the engaging recess 46 and the outer surface of the stem portion, the gap may be filled with the heat transfer grease.

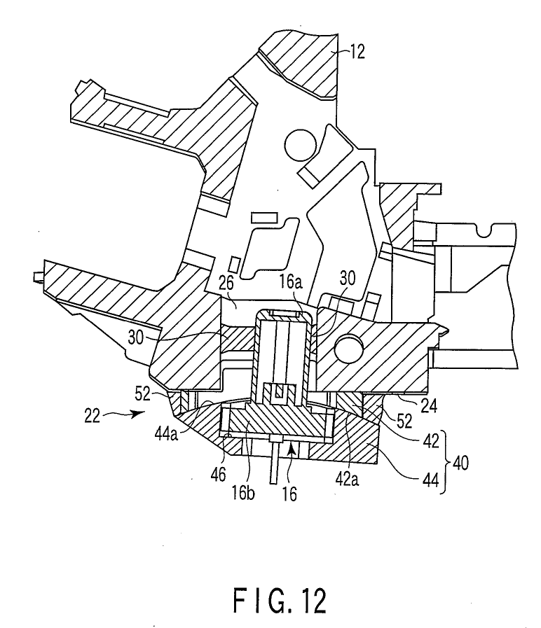

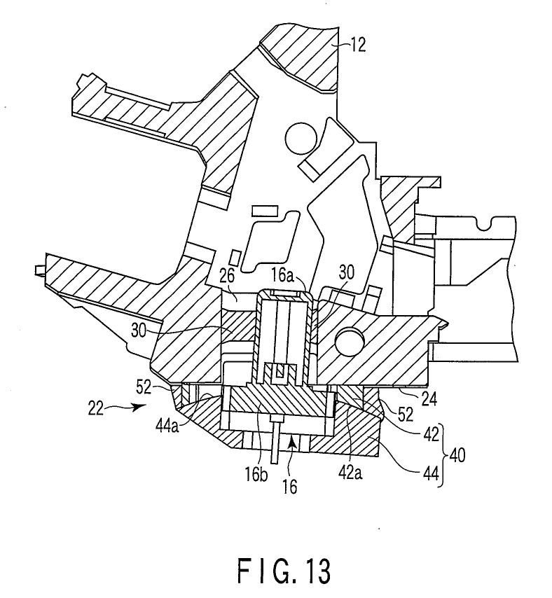

FIG. 4 shows a state that the laser diode 16 itself is accurately produced and fixed to an ideal proper position. In contrast, FIG. 11 shows a state that the proper position, at which the laser diode is fixed after the position thereof is adjusted, inclines, for example, 3° from the ideal position shown in FIG. 4 due to the dispersion inherent to the laser diode 16. FIG. 12 shows a state that the proper position, at which the laser diode is fixed after the position thereof is adjusted, is further offset in the X-axis direction from the fixing position shown in FIG. 11, and FIG. 13 shows a state that the proper position is further offset in the Z-axis direction. As described above, even if the position of the laser diode 16 is adjusted to any of the proper positions, the holder main body 44 is arranged to a proper position following the position of the laser diode only by mounting it on the laser diode, and the holder base is also automatically arranged to the position at which it is in surface contact with the holder main body following the mounting position of the holder main body 44. Accordingly, even if the laser diode 16 is adjusted to any of the proper positions, the heat transfer holder 40 can be easily and securely mounted on the laser diode as well as a high heat transfer property and a high heat radiation property can be realized.

According to the optical pickup device 10 arranged as described above, the laser diode 16 is fixed to the pickup base 12 in a state that it is adjusted to the proper position with respect to the optical system 14, and the heat transfer holder 40 is mounted on the laser diode and the pickup base in a state that it follows the adjusted position of the laser diode. The holder main body is in surface contact with the laser diode in the wide area thereof, and the first contact surface of the holder base is also in surface contact with the pickup base 12. Further, the holder main body and the holder base are in surface contact with each other in the wide areas thereof through the spherical contact surface. Accordingly, the heat of the laser diode can be more effectively transferred to the pickup base and radiated therefrom by the heat transfer holder. With this arrangement, there can be obtained the optical pickup device, which can maintain the performance of the light emitting element excellent in the heat radiation property and improve durability thereof, the method of manufacturing the light emitting element, and the optical disc apparatus.

Further, the heat transfer holder 40 can be mounted without unnaturally applying an external force to the laser diode by moving the holder in the Z-axis direction after the position of the laser diode is accurately adjusted. Accordingly, the position of the laser diode can be accurately maintained. Further, the position of the holder main body is naturally determined following the position of the laser diode, and further the holder base is also aligned to a desired surface contact position following the position of the holder main body. Accordingly, the heat transfer holder can be easily mounted, and a working efficiency is also high. Further, no part is necessary to adjust the position of the heat transfer holder, and a man-hour necessary to assemble it can be also reduced.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

For example, although the second contact surface of the holder base is formed in the concave spherical surface shape and the third contact surface of the holder main body is formed in the convex spherical surface shape in the embodiment described above, the second contact surface may be formed in the convex spherical surface, and the third contact surface may be formed in the concave spherical surface inversely.

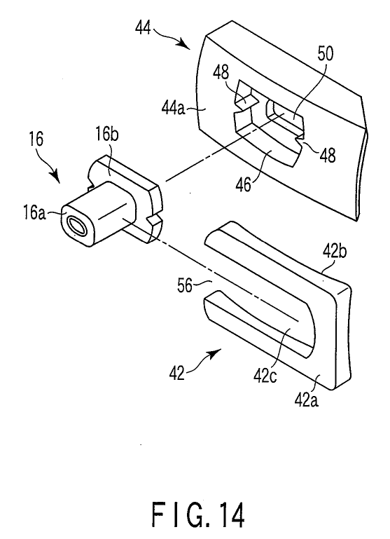

Further, it is sufficient that the holder base be mounted on the laser diode, which is fixed to the adjusted position, from the outside, and the shape of the holder base is not limited to the annular shape and may be formed in other shape. For example, according to another embodiment shown in FIG. 14, a holder base 42 is formed in an approximately U-shape and has an inner hole 42c into which a cap portion 16a of a laser diode 16 is inserted and an opening 56 which communicates with the inner hole as well as allows the cap portion to pass therethrough. The holder base 42 has a first flat contact surface 42a, which comes into surface contact with the abutment surface of a pickup base 12 and a second spherical contact surface 42b which comes into surface contact with a holder main body 44.

When the holder base 42 is mounted, it is arranged to the periphery of the cap portion by causing the cap portion to pass through the opening 56 from the cap portion 16a side, thereby the holder base 42 comes into surface contact with the pickup base. Thereafter, the holder main body 44 is mounted by being overlapped to the laser diode 16 and the holder base 42 likewise the first embodiment described above. The same operation/working effect as that of the first embodiment described above can be obtained even if the holder base 42 of the above arrangement is used.

The light emitting element may be applied to a laser diode for CD media in addition to the laser diode for DVD media. Further, a laser diode which emits two-wavelength laser light for DVD media and CD media may be used as the light emitting element.

What is claimed is:

1. An optical pickup device comprising:
a pickup base;
an optical system held by the pickup base;
a light emitting element which emits a laser beam and is fixed to the pickup base in a state that the position of the light emitting element is adjusted to the optical system; and
a heat transfer holder which is mounted on the pickup base in contact with the light emitting element and transfers the heat of the light emitting element to the pickup base,
the pickup base including a flat abutment surface positioned adjacent to the light emitting element, and the heat transfer holder including:
a holder base arranged to surround the light emitting element so as to cause the light emitting element to pass through the holder base, the holder base having a first flat contact surface which comes into surface contact with the abutment surface, and a second spherical contact surface, which is positioned to a side opposite to the first contact surface, the holder base being movable in a surface direction of the abutment surface with respect to the light emitting element; and
a holder main body overlapped to the holder base to cover the light emitting element, the holder main body having a third spherical contact surface which comes into surface contact with the second contact surface of the holder base, and an engaging recess formed in the third contact surface and having an inner surface which comes into contact with the light emitting element.

2. The optical pickup device according to claim 1, wherein the light emitting element is a laser diode including a cylindrical cap portion having an emitting end, and a stem portion arranged at another end of the cap portion and having a diameter larger than the cap portion,
the laser diode is fixed to the pickup base in a state that the cap portion passes through a through hole of the pickup base and the stem portion projects outside of the pickup base,
the holder base is arranged around the cap portion between the abutment surface of the pickup base and the stem portion, and
the holder main body is arranged on the holder base with the stem portion being fitted in the engaging recess.

3. The optical pickup device according to claim 2, wherein the stem portion has a peripheral surface extending in the optical axis direction, and the engaging recess of the holder main body has an inner surface which comes into surface contact with at least a portion of the peripheral surface of the stem portion.

4. The optical pickup device according to claim 2, wherein the holder base is formed in an annular shape and has an inner hole which extends passing through the first contact surface and has a size for causing the stem portion to pass therethrough.

5. The optical pickup device according to claim 2, wherein the holder base has an inner hole into which the cap portion is inserted and an opening which communicates with the inner hole and allows the cap portion to pass therethrough.

6. The optical pickup device according to claim 1, wherein the second contact surface of the holder base is formed in a concave spherical shape, and the third contact surface of the holder main body is formed in a convex spherical shape.

7. A method of manufacturing an optical pickup device which comprises: a pickup base; an optical system held by the pickup base; a light emitting element which is fixed to the pickup base and emits a laser beam; and a heat transfer holder which is mounted on the pickup base in contact with the light emitting element and transfers the heat of the light emitting element to the pickup base, the pickup base including a flat abutment surface positioned adjacent to the light emitting element, and the heat transfer holder including: a holder base arranged to surround the light emitting element so as to cause the light emitting element to pass through the holder base, the holder base having a first flat contact surface which comes into surface contact with the abutment surface, and a second spherical contact surface, which is positioned to a side opposite to the first contact surface; and a holder main body overlapped to the holder base to cover the light emitting element, the holder main body having a third spherical contact surface which comes into surface contact with the second contact surface of the holder base, and an engaging recess formed in the third contact surface and having an inner surface which comes into contact with the light emitting element, the method comprising:
fixing the light emitting element to the pickup base after the position of the light emitting element is adjusted to the optical system mounted on the pickup base;
arranging the holder base around the light emitting element in a state that the first contact surface of the holder base is caused to come into surface contact with the abutment surface of the pickup base;
covering the holder main body on the light emitting element, moving the holder main body in the optical axis direction of the light emitting element, engaging the light emitting element with the engaging recess, causing the third contact surface of the holder main body to come into surface contact with the second surface of the holder base;
displacing the holder base along the abutment surface thereby aligning the holder base at a position at which the second contact surface comes into surface contact with the third contact surface; and
fixing the holder main body and the holder base to the pickup base after the holder main body is aligned.

8. An optical disc apparatus comprising:
a drive unit which supports and rotates an optical disc; and
an optical pickup device which radiates a laser beam to the optical disc supported by the drive unit and records and reproduces information to and from the optical disc,
the optical pickup device comprising:
a pickup base;
an optical system held by the pickup base;
a light emitting element which emits a laser beam and is fixed to the pickup base in a state that the position of the light emitting element is adjusted to the optical system; and
a heat transfer holder which is mounted on the pickup base in contact with the light emitting element and transfers the heat of the light emitting element to the pickup base,
the pickup base including a flat abutment surface positioned adjacent to the light emitting element, and
the heat transfer holder including:
a holder base arranged to surround the light emitting element so as to cause the light emitting element to pass through the holder base, the holder base having a first flat contact surface which comes into surface contact with the abutment surface, and a second spherical contact surface, which is positioned to a side opposite to the first contact surface, the holder base being movable in a surface direction of the abutment surface with respect to the light emitting element; and
a holder main body overlapped to the holder base to cover the light emitting element, the holder main body having a third spherical contact surface which comes into surface contact with the second contact surface of the holder base, and an engaging recess formed in the third contact surface and having an inner surface which comes into contact with the light emitting element.
